(19) United States
(12) Patent Application Publication
(10) Pub. No.: US 2017/0307053 A1
(43) Pub. Date: Oct. 26, 2017

(54) Gear for an adjusting device in vehicles for adjusting two vehicle parts adjustable with respect to each other

(71) Applicant: IMS Gear SE & Co. KGaA, Donaueschingen (DE)

(72) Inventors: Donatus Riester, Wutach (DE); Christian Geiges, Blumberg (DE); Manuel Hengstler, St. Georgen (DE); Jens Fechler, Hüfingen (DE)

(73) Assignee: IMS Gear SE & Co. KGaA, Donaueschingen (DE)

(21) Appl. No.: 15/493,367

(22) Filed: Apr. 21, 2017

(30) Foreign Application Priority Data
Apr. 22, 2016 (EP) 16 166 538.5

(51) Int. Cl. F16H 25/20; B60N 2/23; B60J 7/057

(52) U.S. Cl. CPC F16H 25/20; B60N 2/233; B60J 7/0573; F16H 2025/2046; F16H 2025/209; F16H 2025/2031

(57) ABSTRACT

A gear for an adjusting device in vehicles for adjusting two vehicle parts adjustable relative to each other, in particular, for adjusting two parts of a seat adjusting device, a window lifter, or a sun roof, the gear including a drivable drive screw having gear teeth, a spindle nut, which has spindle nut teeth engaging with the screw teeth, and an internal thread, using which the spindle nut can be brought into engagement with a threaded spindle of the adjusting device, and a gear housing, which accommodates and supports the drive screw and the spindle nut. The spindle nut is made at least partially of metal, and the drive screw is made of plastic, and the gear housing includes a first bearing section made of plastic for supporting the spindle nut and a second bearing section made of metal for supporting the drive screw.

### CROSS-REFERENCE TO RELATED APPLICATIONS

This application claims priority to European Patent Application No. 16 166 538.5, filed Apr. 22, 2016, which is incorporated by reference in its entirety.

### BACKGROUND

The present application relates to a gear for an adjusting device in vehicles for adjusting two vehicle parts adjustable with respect to each other, in particular, for adjusting two parts of a seat adjustment device, a window lifter, or a sun roof, the gear including a drivable drive screw having screw teeth, a spindle nut, which has spindle nut teeth engaged with the screw teeth and an internal thread, using which the spindle nut may be brought into engagement with a threaded spindle of the adjustment device, and a gear housing, which accommodates and supports the drive screw and the spindle nut.

### SUMMARY

The available space in a vehicle is limited, so that the dimensions of almost all vehicle parts must be reduced as much as possible. The gears that are used for adjusting two vehicle parts adjustable with respect to each other, are no exception. However, the smaller the gears, the higher rotation speeds are needed for adjusting the two vehicle parts along a certain path at the same speed. High rotation speeds, on the other hand, generate a high amount of heat, which in turn may result in increased wear or even failure of the gear components in question if the heat is not removed to a sufficient degree.

In order to make sufficient heat removal possible, it is known that the gear housing may be made entirely of metal. The disadvantages compared to plastic gear housings are the more complicated shaping, increased weight, and increased noise due to the damping behavior. Since the gear housings are also used for supporting the drive screw and the spindle nut, the choices for the material of these elements are limited. Although the gear housings may also be made of a plastic having good heat conductivity, these plastics are expensive, and therefore not suitable for mass production.

In one specific embodiment, the present disclosure provides an easy-to-manufacture gear that, at the same time, provides a long service life.

The present disclosure provides a gear with features and structures recited herein. Advantageous specific embodiments are further recited herein.

One specific embodiment of the present disclosure relates to a gear for an adjusting device in vehicles for adjusting two vehicle parts adjustable with respect to each other, in particular, for adjusting two parts of a seat adjustment device, a window lifter, or a sun roof, the gear including a drivable drive screw having screw teeth, a spindle nut, which has spindle nut teeth engaged with the screw teeth, and an internal thread, using which the spindle nut may be brought into engagement with a threaded spindle of the adjustment device, and a gear housing, which accommodates and supports the drive screw and the spindle nut. The spindle nuts are made at least partially of metal, the drive screw is made of plastic, and the gear housing includes a first bearing section made of plastic for supporting the spindle nut and a second bearing section made of metal for supporting the drive screw.

Due to the fact that the spindle nut is made at least partially of metal, an improved crash behavior is achieved. Spindle nuts made entirely of plastic often fail when subjected to forces that arise in a crash. This is disadvantageous in particular when gears of such a design are used for adjusting vehicle seats. Vehicle seats may be displaced uncontrollably if the spindle nut fails in a crash, which may result in severe injuries to the passengers of the vehicle.

Due to the fact that the metallic spindle nut is mounted in the first bearing section, which is made of plastic, an advantageous pairing of materials is achieved, which is manifested, in particular, in little abrasion compared to mounting in metal, which is achieved without additional bearing elements. For this reason, it is also advantageous to manufacture the drive screw engaged with the spindle nut of plastic, for example, of PEEK (polyether ether ketone). Therefore, the second bearing section, in which the drive screw is mounted, is made of metal. In addition to the advantageous material pairings, good heat removal from the gear is achieved by using metal for the second bearing section, especially since the drive screw usually rotates considerably faster than the spindle nut. However, it is not necessary to design the first and second bearing sections so that they form a bearing surface of the same material completely enclosing the spindle nut and the drive screw, respectively. It is also possible, for example, to form one-half of the bearing surface of metal and the other half of plastic.

In summary, a gear is provided, in which the spindle nut and the drive screw are supported using a metal/plastic material pairing, good heat removal being ensured by mounting the drive screw in metal. This results in increased service life and reduced noise generated by the present gear.

An alternative specific embodiment of the present disclosure relates to a gear for an adjusting device in vehicles for adjusting two vehicle parts adjustable with respect to each other, in particular, for adjusting two parts of a seat adjustment device, a window lifter, or a sun roof, the gear including a drivable drive screw having screw teeth, a spindle nut, which has spindle nut teeth engaged with the screw teeth, and an internal thread, using which the spindle nut may be brought into engagement with a threaded spindle of the adjustment device, and includes a gear housing, which accommodates and supports the drive screw and the spindle nut. The drive screw is made of plastic, and the gear housing includes a first bearing section made of plastic for supporting the spindle nut, in particular, but not necessarily made of metal, and a second bearing section made of metal for supporting the drive screw, the second bearing section having at least one dimension, which is greater than or equal to the largest diameter of the drive screw.

Also in this specific embodiment, improved heat removal from the gear is made possible, in particular due to the fact that the faster rotating drive screw is supported in the second, metallic bearing section, which is particularly long. A large metallic surface is thereby provided compared with a metallic bearing bushing, for example, over which the heat may be removed from the gear and dissipated into the environment.

According to another specific embodiment, the gear housing has a first housing part made of plastic and a second housing part made of metal, the first bearing section being formed, entirely or partially, by the first housing part and the second bearing section being formed, entirely or partially, by the second housing part. It is perfectly possible to provide the second metallic bearing section in the form of sufficiently large bushings, around which the rest of the plastic housing is molded. However, this procedure is relatively complicated from the manufacturing point of view, which increases the production costs. In this specific embodiment, no molding around the second metallic bearing section is required; rather, the two housing parts may be joined together in a suitable manner. Manufacturing is thus simplified, resulting in a lower unit price of the gear.

According to a refined specific embodiment, the first housing part may be inserted into the second housing part to form a joint or vice-versa. The possibility of inserting the two housing parts into one another also simplifies manufacturing, since at the same time the two housing parts may be positioned relative to each other using a relatively simple operation. One of the housing parts may be slightly larger than the other housing part, so that the two parts may be pre-secured by friction fitting, which simplifies the subsequent joining operation. In addition, the likelihood of the two housing parts not being joined as intended is reduced. The reject rate is thereby lowered.

In another specific embodiment, the first housing part may have a first form fitting means and the second housing part may have a second form fitting means, which grip each other in a form-fitting manner. As discussed previously, it is basically possible to join both parts by friction fitting. However, the forces that may be transmitted using friction fitting, especially for plastics, are limited, since plastic deformation during pre-positioning should be prevented. The use of form fitting is therefore available, where the flexibility of plastic can be made use of and snap joints may be provided in a simple manner Form fitting joints also have the advantage that they provide the worker performing the assembly with clear feedback about whether the two housing parts to be joined are actually joined as intended.

In a refined specific embodiment, the first housing part may include a first subshell and a second subshell, at least one of the subshells having first positioning means for positioning the first subshell relative to the second subshell. The first housing part is mainly responsible for bearing the spindle nut. The spindle nut usually has a larger diameter compared to the drive screw, so that the use of both subshells simplifies manufacturing due to the following: The spindle nut may be inserted into the first subshell, and subsequently the second subshell may be attached to the first subshell. Compared to a single-part first housing part, the introduction of the spindle nut is simplified, since no sections of the first housing part block access.

A refined specific embodiment is characterized in that the first subshell and the second subshell are attachable to each other with the aid of the second housing part. In this specific embodiment, the second housing part is used as a pre-positioning means, so that the subsequent joining operation is simplified, since the two subshells are already definitely positioned relative to each other.

Another specific embodiment is characterized in that the first subshell and the second subshell have the same design. The number of different parts of the gear is thus reduced, whereby the costs may be reduced.

In a further specific embodiment, the second housing part includes a first body and a second body, at least one of the bodies having second positioning means for positioning the first body with respect to the second body. Also thereby the assembly is simplified, since the final positioning of the drive screw may be performed before the second housing part is attached to the first housing part.

A refined specific embodiment is characterized in that the first and/or the second positioning means are designed as pins and corresponding bore holes. The use of pins and corresponding bore holes also makes a particularly simple manufacturing possible, since pins are easily inserted into the bore holes. In addition, pins may be configured to be somewhat larger than the boreholes, whereby some pre-securing by friction fitting may be provided. In addition, the pins may be used for the final joining of the housing parts in question, for example, by hot caulking or welding the pins in the bore holes. It is not necessary here that the boreholes be through holes.

In a further specific embodiment, the first body and the second body have the same design, which also makes it possible to reduce the number of different components, which in turn results in lower costs and simplified inventory keeping.

One embodiment of the present disclosure relates to a gear for an adjusting device in vehicles for adjusting two vehicle parts adjustable with respect to each other, in particular, for adjusting two parts of a seat adjustment device, a window lifter, or a sun roof, a threaded spindle being fixedly attached to the first vehicle part, and the adjusting device having a gear according to one of the above-described specific embodiments, whose spindle nut is engaged, using its internal thread, with the threaded spindle, and whose gear housing is attached to the second vehicle part non-adjustably in its direction of adjustment.

The technical effects and advantages that may be achieved using the proposed adjusting device correspond to those discussed for the present gear. In summary, it should be pointed out that a gear is provided in which the spindle nut and the drive screw are each mounted using a low-noise and low-wear metal/plastic material pairing, good heat removal being provided due to the drive screw being mounted in metal. Longer service life and reduced noise generation by the present gear result therefrom. This allows the functionality of the adjusting device to be maintained longer and comfort to be enhanced.

One embodiment of the present disclosure relates to a vehicle seat, which is adjustable with the aid of an adjusting device as described above. The technical effects and advantages that may be achieved using the proposed vehicle seat correspond to those discussed for the present gear. In summary, it should be pointed out that a gear is provided in which the spindle nut and the drive screw are each mounted using a low-noise and low-wear metal/plastic material pairing, good heat removal being provided due to the drive screw being mounted in metal. Longer service life and reduced noise generation by the present gear result therefrom. The vehicle seat may be adjusted over a longer time period in a more convenient manner.

### BRIEF DESCRIPTION OF THE DRAWINGS

Exemplary specific embodiments of the present disclosure are elucidated in greater detail in the following with reference to the appended drawing.

FIG. 1 shows a perspective view of an adjusting device, in this case for seat adjustment, in which a gear according to the present disclosure may be used;

FIG. 2a) shows a first exemplary embodiment of a gear according to the present disclosure in the assembled state in a perspective view;

FIG. 2b) shows the first exemplary embodiment in an exploded view;

FIG. 2c) shows the first exemplary embodiment in a schematic partially sectioned view;

FIG. 3a) shows a second exemplary embodiment of a gear according to the present disclosure in the assembled state in a perspective view;

FIG. 3b) shows the second exemplary embodiment in an exploded view;

FIG. 4a) shows a third exemplary embodiment of a gear according to the present disclosure in the assembled state in a perspective view;

FIG. 4b) shows the third exemplary embodiment in an exploded view;

FIG. 5a) shows a fourth exemplary embodiment of a gear according to the present disclosure in the assembled state in a perspective view;

FIG. 5b) shows the fourth exemplary embodiment in an exploded view;

FIG. 6a) shows a fifth exemplary embodiment of a gear according to the present disclosure in the assembled state in a perspective view;

FIG. 6b) shows the fifth exemplary embodiment in an exploded view;

FIG. 7a) shows a seventh exemplary embodiment of a gear according to the present disclosure in the assembled state in a perspective view, and

FIG. 7b) shows the seventh exemplary embodiment in an exploded view;

### DETAILED DESCRIPTION

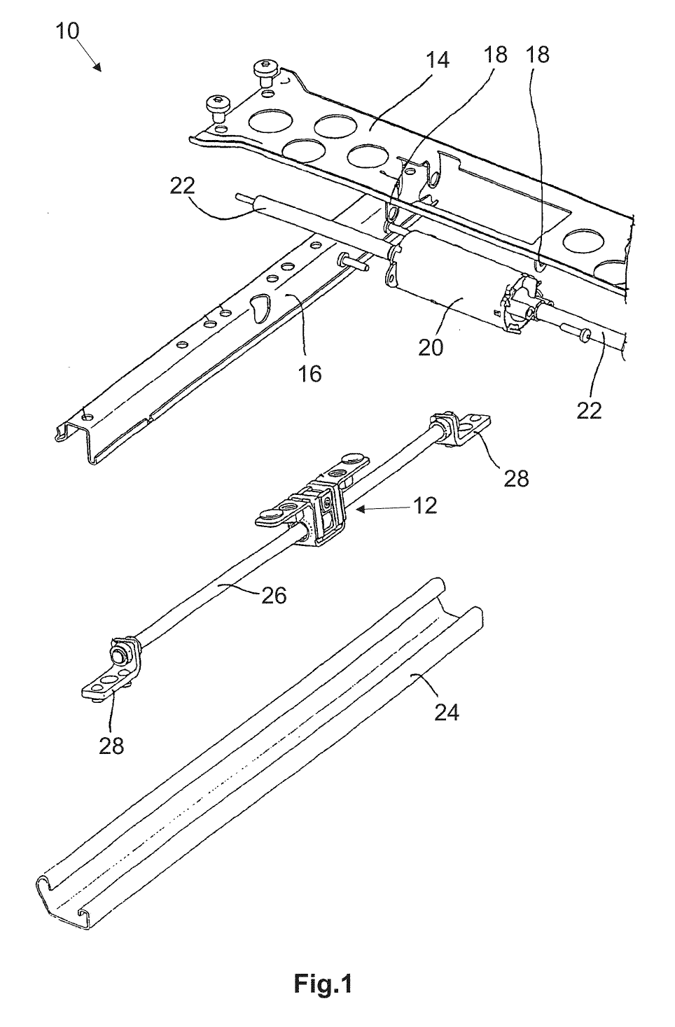

FIG. 1 shows a perspective view of an adjusting device 10, in this case for a seat adjustment, in which a gear 12 according to the present disclosure may be used. Adjusting device 10 has a holding plate 14, which is assigned to an upper rail 16. Attachment lugs 18 for a drive motor 20 are provided on holding plate 14, so that drive motor 20 can be fixedly attached to holding plate 14 and thus to upper rail 16. The frame of the vehicle seat not illustrated here is attached to upper rail 16. Drive shafts 22 are situated on both sides of drive motor 20. These drive shafts 22 establish the connection to gear 12, which is described in greater detail below. Upper rail 16 slides directly or over adjusting and/or bearing elements (not illustrated) on a lower rail 24 attached to the vehicle floor. In the functional position of upper rail 16 and lower rail 24, these are guided so that a cavity is formed. A threaded spindle 26, non-rotatably supported in supports 28, which are fixedly situated on lower rail 24, is situated in this cavity. Threaded spindle 26 cooperates with gear 12, which is also situated in the cavity and is fixedly supported in upper rail 16. Lower rail 14 and upper rail 16 are therefore an example of two vehicle parts adjustable relative to each other.

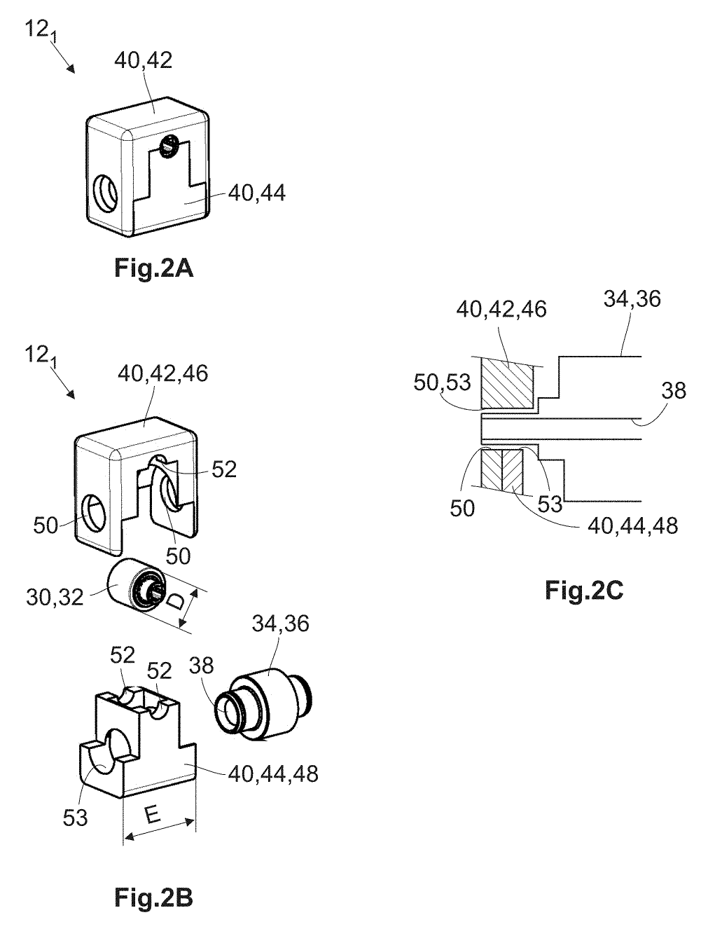

FIG. 2a) shows a first exemplary embodiment of a gear 12₁ according to the present disclosure in fully assembled state, and FIG. 2b) in an exploded view. Gear 12₁ has a drive screw 30, which carries screw teeth 32 on its outer periphery. In the area of screw teeth 32, drive screw 30 shown has its largest diameter D. Drive screw 30 may be non-rotatably connected to drive shafts 22 of drive motor 20 (see FIG. 1).

Furthermore, gear 12 includes a spindle nut 34, which has spindle nut teeth 36 on its outer periphery. In addition, spindle nut 34 has an internal thread 38, which can be brought into engagement with threaded spindle 26 illustrated in FIG. 1.

Gear 12 also has a gear housing 40, which in the example shown includes a first housing part 42 and a second housing part 44. First housing part 42 forms a first bearing section 46 and second housing part 44 forms a second bearing section 48. First bearing section 46 forms two first bearing surfaces 50, which in the assembled state contact the ends of spindle nut 34. Similarly, second bearing section 48 forms two bearing surfaces 52, which in the assembled state of gear 12 contact the ends of drive screw 30. In addition, the two ends of spindle nut 34 are also supported on further bearing surfaces 53, whose lower first half is formed by second bearing section 48, and (not visible in FIGS. 2a) and 2b)), whose upper second half is formed by first bearing section 46. Therefore, FIG. 2c) shows a schematic, not-to-scale through gear 12₁ in the assembled state. First bearing surfaces 50 formed by first bearing section 46 and further bearing surfaces 53 may merge with each other without interruption. Alternatively, shoulders (not illustrated) may be provided. In contrast, the lower halves of first bearing surfaces 50 and of further bearing surfaces 53 can be clearly distinguished from each other, since, as mentioned previously, the lower half of bearing surfaces 53 is formed by second bearing section 48. The lower half of further bearing surfaces 53 is therefore made of metal. In order to prevent increased erosion between second bearing surface 48 and spindle nut 34 in the axial direction and increased noise generation, first bearing section 46 may protrude in the axial direction to the center of gear housing 40 over second bearing section 48. Furthermore, spindle nut 34, as shown, may have a shoulder between the two ends and spindle nut teeth 36. Therefore, spindle nut 34 rests axially on first plastic bearing section 46 using its shoulder, rather than on second bearing section 48, which is advantageous compared with resting axially on second metallic bearing section 48, in particular because axial forces are usually greater than radial forces. In the example shown, drive screws 30 are made of plastic, and spindle nuts 34 are made of metal. It is also possible that spindle nut 34 is not made entirely of metal, but partly of metal and partly of plastic. Spindle nut 34 is mounted with both of its ends in first bearing section 46, which is made of plastic. In the example shown, first bearing section 46 and first bearing surface 50 are formed entirely by first housing part 42, first housing part 42 being made entirely of plastic. As mentioned, spindle nut 34 is also mounted partially in second bearing section 48 in this exemplary embodiment. First housing part 42 may be manufactured by injection die casting, for example.

As mentioned previously, drive screw 30 is made of plastic and is supported with both of its ends in second bearing section 48. However, in the example shown, second bearing surfaces 52 are formed not entirely, but only partially by second housing part 44, which is made of metal. Second housing part 44 may be made, for example, by a zinc pressure die casting process. Second bearing surfaces 52 are also formed by first plastic housing part 42. The selection of the plastic is determined in particular by its bearing properties and its cost. POM (polyoxymethylene), PPS (polyphenylene sulfide), PTFE (polytetrafluoroethylene), and LCP (liquid crystal polymers) suitable. Second bearing section 48 includes not only second bearing surfaces 52, which are contacted by drive screw 30 during operation, but also the bearing structure needed for supporting drive screw 30. In this case, second bearing section 48 includes the entire second housing part 44. Second bearing section 48 has at least one dimension E that is greater than or equal to the largest diameter D of drive screw 30. The direction of extension is not limited to a single plane.

To assemble the first exemplary embodiment of gear 12₁, spindle nut 34 is introduced into second housing part 44, and drive screw 30 is placed with both of its ends on second housing part 44 and, in particular, on the lower half of second bearing surfaces 52. First housing part 42 is then placed over second housing part 44, spindle nut 34 being situated so that it contacts one of first bearing surfaces 50 of first housing part 42 with both of its ends. The two housing parts 42, 44 are than joined to each other, for which any suitable method of joining can be used, for example, ultrasound welding, laser welding, clipping, caulking, hot caulking, or crimping.

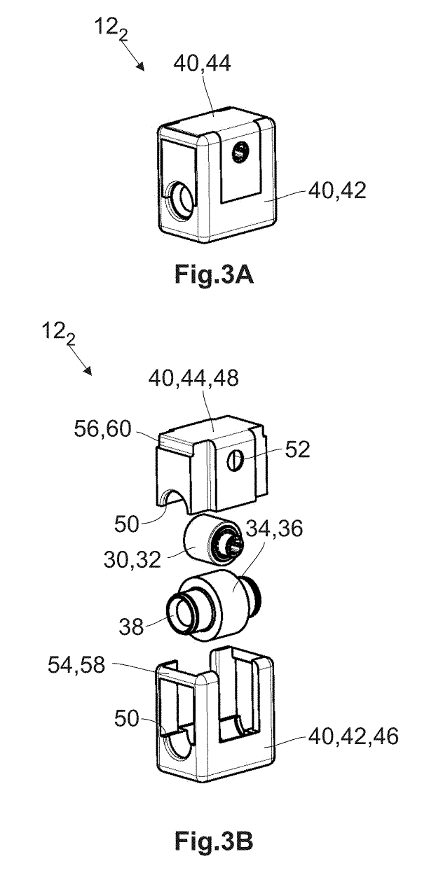

FIGS. 3a) and 3b) show a second exemplary embodiment of gear 12₂ according to the present disclosure. Also in this exemplary embodiment, gear housing 40 has first housing part 42 and second housing part 44. However, in this exemplary embodiment, second bearing surface 52 for drive screw 30 is entirely formed by second housing part 44, while one-half of first bearing surface 50 for spindle nut 34 is formed by first housing part 42 and one-half by second housing part 44. First housing part 42 has first form fitting means 54 and second housing part 44 has second form fitting means 56, first form fitting means 54 being designed as cross webs 58, which in the assembled state engage in corresponding recesses 60 of second housing part 44.

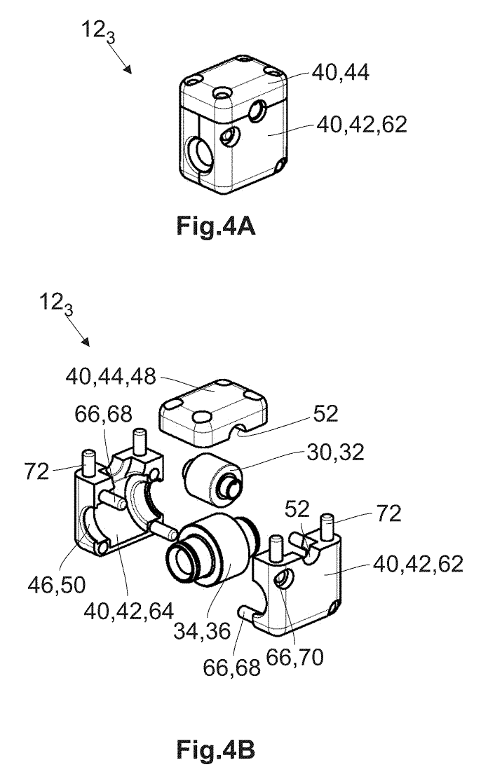

FIGS. 4a) and 4b) show a third exemplary embodiment of gear 12₃ according to the present disclosure, in which first housing part 42 has a first subshell 62 and a second subshell 64. First subshell 62 and second subshell 64 have the same design and have first positioning means 66, which in the example shown include two pins 68, which in the assembled state engage in a corresponding number of bore holes 70. The two subshells 62, 64 have further pins 72, which are perpendicular to pins 68 and on which the cover-shaped second housing part 44 can be mounted when the two subshells 62, 64 are joined to lock the two subshells 62, 64 together. In this exemplary embodiment, first bearing section 46 and thus first bearing surface 50 are entirely formed by first housing part 42, while one-half of second bearing surface 52 is formed by first housing part 42 and the other half by second housing part 44.

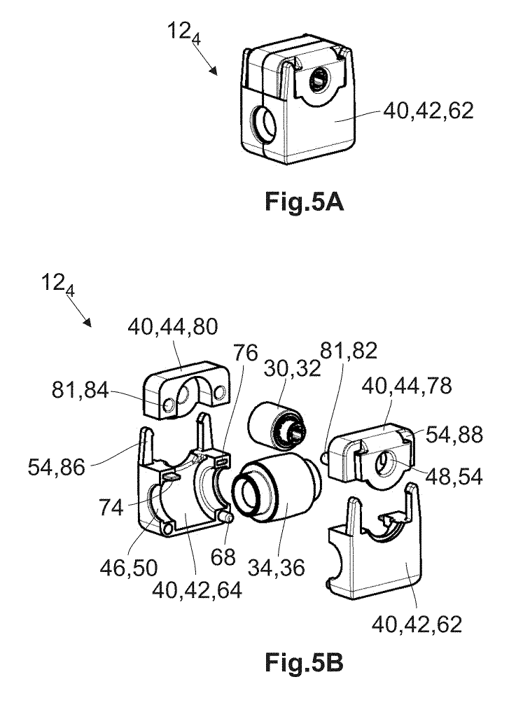

FIGS. 5a) and 5b) show a fourth exemplary embodiment of gear 12₄ according to the present disclosure, first housing part 42 being again formed by first subshell 62 and second subshell 64. Subshells 62, 64 are, however, somewhat different, unlike in the third exemplary embodiment. There is only one pin 68 per subshell 62, 64, while, instead of the second pin, a tongue 74 is provided, which in the joined state engages in a mating recess 76.

Second housing part 44 has a first body 78 and a second body 80, which are provided with second positioning means 81. In this exemplary embodiment, second positioning means 81 include two pins 82, which are situated on first body 78 and engage in a corresponding number of bore holes 84 of second body 80. First and second bodies 78, 80 are therefore not of the same design.

First subshell 62 and second subshell 64 together form first bearing section 46; first body 78 and second body 80 together form one of second bearing sections 48.

The two subshells 62, 64 have first form fitting means 54, which in this case are designed as latching arms 86. Second form fitting means 56 are designed as shoulders 88 on first and second bodies 78, 80. For the assembly, first body 78 and second body 80 of second housing part 44 are joined together so that drive screw 30 is accommodated in second bearing sections 48. First subshell 62 and second subshell 64 are then joined together so that spindle nut 34 is supported in first bearing section 46. Finally, second housing part 44 is placed onto first housing part 42. Latching arms 86 engage behind recesses 88, whereby a form fitting joint is formed.

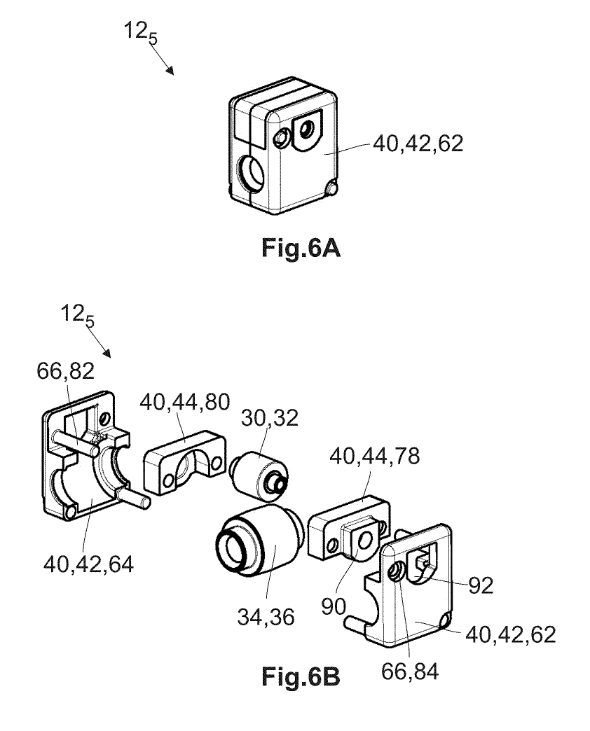

FIGS. 6a) and 6b) show a fifth exemplary embodiment of gear 12₅ according to the present disclosure, which has a design similar to that of gear 12₄ according to the fourth exemplary embodiment (see FIG. 5). However, there are no first form fitting means 54. Instead, first and second bodies 78, 80 have elevations 90, which in the assembled state engage in a window 92 of the respective subshells 62, 64. Therefore, although first and second bodies 78, 80 are positioned relative to the corresponding subshells 62, 64, they are not locked in this position. Subshells 62, 64 have the same design, first positioning means 66 including two pins 82, which in the assembled state engage in a corresponding number of bore holes 84 on the other subshell 62, 64.

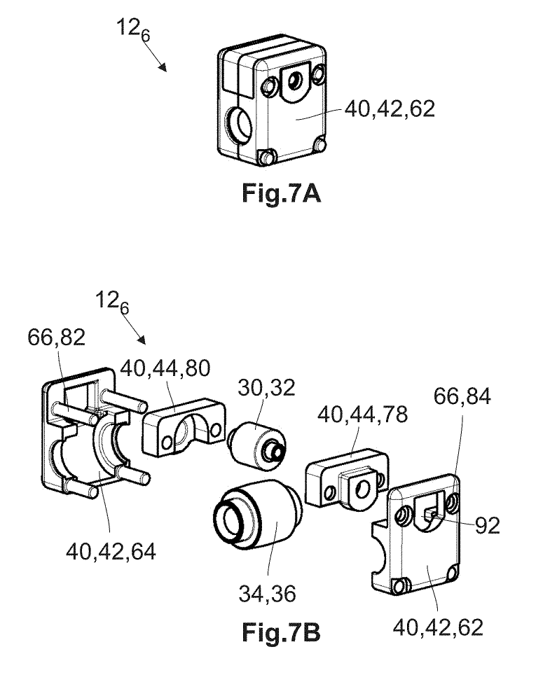

FIGS. 7a) and 7b) show a sixth exemplary embodiment of gear 12₆ according to the present disclosure, which has a design very similar to that of the exemplary embodiment shown in FIG. 6. However, in this case, the two subshells 62, 64 do not have the same design, but the second subshell 64 has four pins 82, which engage in four bore holes 84 of second subshell 64.
10 adjusting device
12, 12₁-12₆ gear
14 holding plate
16 upper rail
18 fastening lug
20 drive motor
22 drive shaft
24 lower rail
26 threaded spindle
28 support
30 drive screw
32 screw teeth
34 spindle nut
36 spindle nut teeth
38 internal thread
40 gear housing
42 first housing part
44 second housing part
46 first bearing section
48 second bearing section
50 first bearing surface
52 second bearing surface
53 other bearing surface
54 first form fitting means
56 second form fitting means
58 cross web
60 recess
62 first subshell
64 second subshell
66 first positioning means
68 pin
70 bore hole
72 other pin
74 tongue
76 recess
78 first body
80 second body
81 second positioning means
82 pin
84 bore hole
86 latching arm
88 shoulder
90 elevation
92 window
D diameter
E dimension

What is claimed:

1. A gear for an adjusting device in vehicles for adjusting two vehicle parts adjustable relative to each other, the gear comprising:
a drivable drive screw having drive screw gear teeth,
a spindle nut comprising,
spindle nut teeth that engage with the drive screw gear teeth, and
an internal thread, that engages with a threaded spindle of the adjusting device, and
a gear housing, which accommodates and supports the drive screw and the spindle nut, and
wherein the spindle nut is made at least partially of metal, and the drive screw is made of plastic, and
the gear housing includes a first bearing section made of plastic for supporting the spindle nut and a second bearing section made of metal for supporting the drive screw.

2. The gear according to claim 1, wherein the adjusting device adjusts two parts of the group consisting of a vehicle seat, a vehicle window lifter and a vehicle sun roof.

3. The gear according to claim 1, wherein the gear housing comprises:
a first housing part made of plastic; and
a second housing part made of metal,
wherein the first bearing section is formed at least partially by the first housing part, and
wherein the second bearing section is formed at least partially by the second housing part.

4. The gear according to claim 3, wherein the first housing part and the second housing part insert into each other to form a joint.

5. The gear according to claim 4, wherein the first housing part has first form-fitting engagement structure and the second housing part has second form-fitting engagement structure, which engage in each other in a form-fitting manner to form the joint.

6. The gear according to claim 1, further comprising:
a the first housing part that includes a first subshell and a second subshell, wherein at least one of the first subshell or the second subshell has first positioning pins and corresponding first positioning bore holes for positioning the first subshell relative to the second subshell.

7. The gear as recited in claim 6, wherein the first subshell and the second subshell are attachable together with the aid of the second housing part.

8. The gear according to claim 6, wherein the first subshell and the second subshell have a same design.

9. The gear according to claim 6, wherein the second housing part comprises a first body and a second body, and wherein at least one of the first body or the second body has second positioning pins and corresponding second positioning bore holes for positioning the first body relative to the second body.

10. The gear according to claim 9, wherein the first body and the second body have a same design.

11. The gear according to claim 1, where the gear operates a spindle of the adjusting device, wherein the a spindle nut engages with the threaded spindle using an internal thread of the spindle nut, and wherein an assembled gear housing is connected to a second vehicle part non-displaceably in its adjusting direction.

12. The gear according to claim 11, wherein the adjusting device is a vehicle seat adjusting device.

13. A gear for an adjusting device in vehicles for adjusting two vehicle parts adjustable relative to each other, the gear comprising:
a drivable drive screw having drive screw gear teeth,
a spindle nut, comprising,
spindle nut teeth that engage with the drive screw gear teeth, and
an internal thread, that engages with a threaded spindle of the adjusting device, and
a gear housing, which accommodates and supports the drive screw and the spindle nut, and
wherein the drive screw is made of plastic, and
the gear housing includes a first bearing section made of plastic for supporting the spindle nut and a second bearing section made of metal for supporting the drive screw, the second bearing section having at least one dimension that is at least as large as a largest diameter of the spindle nut.

14. The gear according to claim 13, wherein the adjusting device adjusts two parts of the group consisting of a vehicle seat, a vehicle window lifter and a vehicle sun roof.
